(19) United States
(12) Patent Application Publication
(10) Pub. No.: US 2004/0049571 A1
(43) Pub. Date: Mar. 11, 2004

(54) Tracking document usage

(76) Inventors: Bruce L. Johnson, Eagle, ID (US); Leonard T. Schroath, Boise, ID (US); Bradley J. Anderson, Boise, ID (US); William I. Herrmann, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/236,441

(22) Filed: Sep. 6, 2002

(51) Int. Cl. G06F 15/173

(52) U.S. Cl. 709/224

(57) ABSTRACT

A system and methods enable the gathering and transferring of usage information for an electronic document so that the document's usage history can be tracked. A document history is recorded into an electronic document through the execution of a tracking module located within the electronic document. When the electronic document is accessed, the tracking module executes to record document history information into the electronic document. The disclosed system and methods provide a convenient way to track secured documents, maintain document databases, and offer feedback to authors on how documents are used so that document contents can be tailored to better suit the needs of an audience.

### TECHNICAL FIELD

The present disclosure relates to tracking the usage of an electronic document after creation of the document, and more particularly, to providing document usage history information to the document's author or other interested party.

### BACKGROUND

Various application programs generate information about electronic files/documents as the electronic files/documents are created within the application programs. Information is typically saved within an electronic document under various properties of the document. These properties are viewable by users through a document properties tab accessible through a pull-down menu within an application. Although document property information may vary based on the application program used to generate the document, the information is typically related to the document's creation. The information might therefore be categorized into properties such as an origination property that includes the document's author, creation date, revision number, who last saved the document and the date they saved it. Another property might be a statistical property containing information such as the number of pages, paragraphs, lines, words, and characters the document contains.

Although such information may be useful to an author during the composition or creation of a document, it does not help in understanding how the document is used after its completion. Information regarding how a document is used after it has been created may be useful for various purposes. For example, print history information including when, where, and by whom a document has been printed may be a useful tool to help track the use of the document. Such information may be of particular benefit for tracking the use of secure documents that have restricted access. Such print history information might also be useful in maintaining document databases and for metrics reporting purposes. For example, documents that have little or no print history over a given time period may be deemed to be of little or no use. Such documents might therefore be removed from a database. However, documents having recently active print histories might be retained in a database based on the indication from the print history information that these documents continue to be useful.

Other document usage information can help a document's author understand how the document might be beneficially modified, or how similar documents might be drafted or created in the future to better suit the needs of an intended audience. For example, information such as who reads a document, what sections are being read, what sections are not being read, how many times the document is copied and/or printed, and so on, may help an author understand audience demographics. This information may help an author tailor a document so that its contents are better suited for the audience.

Accordingly, the need exists for a way to accumulate document history information for individual electronic documents and to convey such information back to the authors or sources of such documents.

### SUMMARY

A document history is recorded into an electronic document through the execution of tracking code located within the electronic document. When the electronic document is accessed, the tracking code or module executes to record document history information into the electronic document.

In a particular embodiment, accessing an electronic document initiates the execution of tracking code that records details of the accessing into the electronic document. Accessing the electronic document can include actions such as opening the document, copying the document, printing the document, and attaching the document to an email message. The document history information recorded into the electronic document may include details such as the identification of a computer that initiates an access, what sections of a document are viewed during an access, the identification of a printer used if the document is printed during an access, and the date and time of an access.

In another embodiment, in addition to recording document history information into an electronic document, tracking code transfers document history information to a networked computer based on an address stored within the tracking code. The networked computer is configured to compile document history information from various sources and create a document usage tree that illustrates the usage history of a given document.

### BRIEF DESCRIPTION OF THE DRAWINGS

The same reference numbers are used throughout the drawings to reference like components and features.

FIG. 1 illustrates a system environment that is suitable for tracking the usage of an electronic document.

FIG. 2 is a block diagram illustrating in greater detail, an exemplary embodiment of a server and a client computer such as those shown in FIG. 1.

FIG. 3 is an example of a document usage tree illustrating compiled document usage history information.

FIG. 4 is a block diagram illustrating in greater detail, an exemplary embodiment of client computers such as those shown in FIG. 1.

FIG. 5 is a flow diagram illustrating an example method of tracking the usage of an electronic document.

FIG. 6 is a flow diagram illustrating an alternative example method of tracking the usage of an electronic document.

FIG. 7 is a flow diagram illustrating another alternative example method of tracking the usage of an electronic document.

FIG. 8 is a flow diagram illustrating yet another alternative example method of tracking the usage of an electronic document.

### DETAILED DESCRIPTION

A system and methods enable the gathering and transferring of usage information for an electronic document so that the document's usage history can be tracked. The disclosed system and methods provide a convenient way to track secured documents, maintain document databases, and offer feedback to authors on how documents are used so that document contents can be tailored to better suit the needs of an audience.

Exemplary System Environment for Tracking the Usage of an Electronic Document

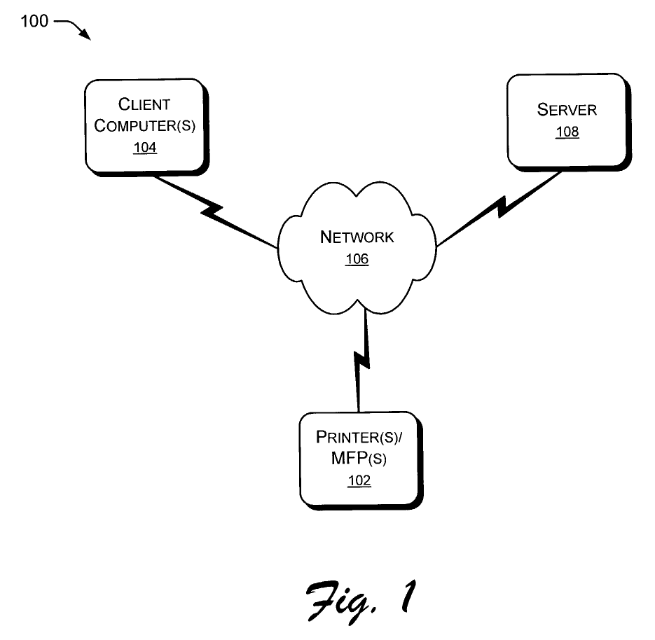

FIG. 1 illustrates an exemplary system environment that is suitable for tracking the usage of an electronic document. The exemplary system environment 100 of FIG. 1 includes printing and/or MFP (multi-function peripheral) device(s) 102, client computer(s) 104, and server 108 operatively coupled through a network connection 106. The communication network 106 can include both local and remote connections depending on the particular system configuration. Thus, network connection 106 may include, for example, a printer cable, a LAN (local area network), a WAN (wide area network), an intranet, the Internet, and other such suitable communications links. Network connection 106 can also include wireless communications links such as IR (infrared) or RF (radio frequency) links.

This disclosure is applicable to various types of printing devices 102 (printers) capable of rendering PDL (page description language) data in printed form on a print medium, such as printing pixels on paper. Therefore, printing/MFP device 102 can include devices such as laser-based printers, ink-based printers, dot matrix printers, dry toner printers, plotters and the like. In addition, printing/MFP device 102 can include various multi-function peripheral devices that combine a printing function with other functions such as faxing, scanning, copying and the like.

Client computer 104 can be implemented as a variety of general purpose computing devices including, for example, a personal computer (PC), a laptop computer, a palmtop computer, a Macintosh, a workstation computer, and other devices configured to communicate with printer/MFP 102 and server 108. Client computer 104 typically provides a user with the ability to manipulate or otherwise prepare an electronic document that can be rendered as hardcopy output by printer/MFP 102 after transmission over network 106. Such electronic documents might also be transmitted over network 106 to server 108 for storage and/or further manipulation. As discussed more fully below with respect to particular embodiments, client computer 104 may be configured to generate an electronic document with tracking code capable of storing document history information into the document. Client computer 104 may also be configured to receive document history information and generate a document usage tree that illustrates the usage history of a given document.

Server 108 is typically implemented as one of a variety of general purpose computing devices such as a workstation computer or Web server. Server 108 generally provides storage for electronic documents and information including various multi-media that it makes accessible to Client computer(s) 104. Server 108 may also perform various network functions such as print server functions for a printer/MFP 102. As discussed more fully below with respect to particular embodiments, server 108 may be configured to receive document history information and generate a document usage tree that illustrates the usage history of a given document.

Exemplary System Embodiments for Tracking the Usage of an Electronic Document

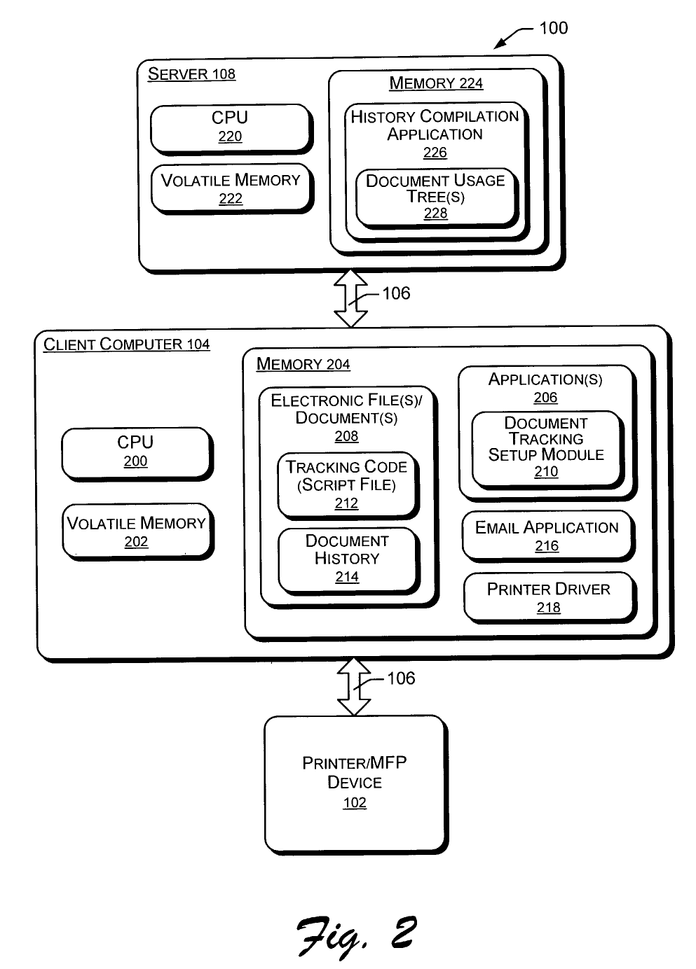

FIG. 2 is a block diagram illustrating a particular embodiment of a client computer 104 and a server 108 as might be implemented in the system environment 100 of FIG. 1. FIG. 2 additionally includes a block representing a printer/MFP 102 for purposes of discussing general functional aspects of the system 100. Client computer 104 typically includes a processor 200, a volatile memory 202 (i.e., RAM), and a nonvolatile memory 204 (e.g., ROM, hard disk, floppy disk, CD-ROM, etc.). Nonvolatile memory 204 generally provides storage of computer/processor-readable instructions, data structures, program modules and other data for client computer 104.

Client computer 104 may implement various application programs 206 stored in memory 204 and executable on processor 200 to generate an electronic document file 208 (e.g., text and graphics). Generally, an electronic document file 208 is displayable on a computer screen and transferable over network connection 106 for rendering as hardcopy output from a printer/MFP 102, or for sharing with other client computers 104 after storage on a server 108. Applications 206 include software programs implementing, for example, word processors, spreadsheets, browsers, multimedia players, illustrators, computer-aided design tools and the like. Therefore, an electronic document 208 can include a wide range of electronic document file types including text files, graphics files, drawing files, spreadsheet files, movie files, music files, and so on.

In the current embodiment of FIG. 2, applications 206 additionally support one or more scripting languages and include a document tracking setup module 210. Scripting languages supported by an application 206 might include, for example, languages such as Java, Perl, Python, Visual Basic, or C-Sharp. Document tracking setup module 210 executes as part of an application 206 to insert (i.e., save, install, embed) a tracking module or tracking code (e.g., a script file) 212 into an electronic document 208 sometime during the generation of the electronic document 208. For example, a word processing application 206 supporting a particular scripting language may insert tracking code 212 into an electronic document file 208 at the time a user originates the document 208 from within the application 206, or when a user first saves the document 208. Likewise, a spreadsheet application 206 supporting a particular scripting language may insert tracking code 212 into an electronic spreadsheet document file 208 at the time a user originates the document 208 from within the application 206, or when a user first saves the spreadsheet document 208 or closes the spreadsheet document 208.

In addition to inserting tracking code 212 into an electronic document 208, document tracking setup module 210 also embeds return address information into the tracking code 212. Document tracking setup module 210 may embed pre-designated return address information into the tracking code 212, or it may enable a user to provide user-designated return address information. As discussed more fully below, the return address information allows the tracking code 212 to transfer document history 214 information to a known location for compilation.

Accessing an electronic document 208 through an application program 206 triggers the execution of the embedded tracking code 212 if the application program 206 supports the scripting language of the tracking code 212. Accessing an electronic document 208 can include any manner of activation of the document 208 by an appropriate application program 206 or action performed by such an application program 206. For example, accessing an electronic word processing document 208 can include opening the document 208 with an appropriate word processing application program 206. Accessing can also include the action of printing the document 208 from within the word processing application program 206. Likewise, accessing an electronic spreadsheet document 208 can include opening the document 208 with an appropriate spreadsheet application program 206 and/or printing the spreadsheet document 208 from within the spreadsheet application program 206. Other examples of accessing an electronic document 208 include making an electronic copy of an electronic document 208 and attaching an electronic document 208 to an email message. It is noted that the accessing events or actions provided in this disclosure are provided by way of example only, and not by way of limitation. Thus, various other accessing events or actions not mentioned are contemplated by this disclosure.

Tracking code 212 includes executable instructions generally configured to generate and store document history 214 information as part of the electronic document 208. As discussed more thoroughly below, tracking code 212 is also configured with return address information that facilitates the transfer of document history 214 information (e.g., through email application 216) to a central location for compilation.

Generally, document history 214 information includes various details such as timing and identification data that are related to the particular accessing event or action that triggers the execution of tracking code 212. Thus, opening an electronic word processing document 208 may result in the recording into the document 208 of a date and time of the opening, as well as an identification of the computer on which the document 208 is opened. With each access of an electronic document 208, embedded tracking code 212 records additional document history 214 information into the electronic document 208 such that the electronic document 208 carries with it an historical accounting of how the document 208 has been used since its creation.

Examples of document history 214 information that might be recorded into an electronic document 208 through the execution of embedded tracking code 212 include the particular type of access that triggers the execution of tracking code 212 (e.g., opening, printing, attaching a document 208), the identification and address of a computer 104 and/or user that initiates an access, the date and time of an access, the identification of a printing device 102 that implements a document printing access, and the sections of a document 208 that are viewed during an access. It is noted that the items of document history 214 information provided in this disclosure are provided by way of example only, and not by way of limitation. Thus, various other items of document history 214 information not specifically mentioned herein are nevertheless contemplated by this disclosure.

Memory 204 of client computer 104 may additionally include one or more device drivers such as printer driver 218. A printer driver 218 usually executes when a print command is selected from a menu within an application program 206. Printer drivers 218 are generally configured to convert electronic document 208 data from a native application 206 file format to a printer-friendly format before the document 208 is sent to a printer/MFP 102 for rendering as hardcopy output. The printer-friendly format is a PDL (page description language) such as PCL or PostScript that is suitable for the particular printer/MFP 102.

Like client computer 104, server 108 typically includes a processor 220, a volatile memory 222, and a nonvolatile memory 224. In the current embodiment of FIG. 2, memory 224 includes a history compilation application 226. History compilation application 226 is configured to generate one or more document usage trees 228 from document history 214 information received from client computer(s) 104. Document usage trees 228 are stored in memory 224 either as part of the history compilation application 226 or in association with the history compilation application 226.

As briefly mentioned above, tracking code 212 is configured with return address information to enable the transfer of document history 214 information (e.g., through email application 216) to a central location (e.g., server 108) for compilation via a history compilation application 226. Accordingly, in addition to generating and storing document history 214 information as part of an electronic document 208, tracking code 212 is also configured to determine if a client computer 104 has an email application 216 or some other suitable file transfer mechanism such as a file transfer protocol (FTP). Tracking code 212 initiates an available file transfer mechanism (e.g., an email application 216 or FTP) on client computer 104 for the purpose of sending document history 214 information to a server 108. For example, tracking code 212 may activate an email application 216 and cause an email message with an attached document history 214 to be sent to a predefined address location. Thus, upon its insertion into an electronic document 208, tracking code 212 includes appropriate predefined address information that it uses to transfer document history 214 information to server 108. In the current embodiment of FIG. 2, the predefined address location is an address that identifies a history compilation application 226 on server 108 as the recipient.

Upon receipt of document history 214 information for a particular electronic document 208, history compilation application 226 on server 108 compiles it with other information that may already have been received corresponding to the particular electronic document 208. History compilation application 226 generates a record of usage such as a document usage tree 228 for each electronic document 208 based on all document history 214 information it receives for each electronic document 208. If a usage record, or document usage tree 228 already exists for a particular electronic document 208, any additional document history 214 information received for that document is compiled into the existing document usage tree 228. However, if no document usage tree 228 exists for a particular electronic document 208, history compilation application 226 generates a new document usage tree 228 when it receives document history 214 information for that particular electronic document 208. Accordingly, part of the compilation process includes eliminating duplicate information that may be received from two or more copies of the same electronic document 208.

For example, a first copy of an electronic document 208 may be accessed several times, and then be copied to a second copy. Document history 214 information regarding the several accesses will likely have been sent to a server 108 for compilation into a document usage tree 228 by a history compilation application 226. The several accesses to the first copy of electronic document 208 may include, for example, one opening by an application program 206 and two printings from a printer 102. Because the several accesses occurred before the second copy of electronic document 208 was made, both the first copy and the second copy will contain document history 214 that includes information regarding the several accesses. Therefore, subsequent accesses made to the second copy of electronic document 208 may result in duplicate document history 214 being sent to server 108 for compilation into the existing document usage tree 228. Thus, history compilation application 226 eliminates duplicate information before compiling newly received document history 214 information into a document usage tree 228.

FIG. 3 shows an example of a document usage tree 228 that might be generated by a history compilation application 226 on server 108 of FIG. 2. In general, the document usage tree 228 might be accessible to system administrators, electronic document 208 authors, and other authorized personnel having access to and knowledge of the history compilation application 226 on server 108. It is noted that the document usage tree 228 of FIG. 3 is provided by way of example only, and not by way of limitation. Thus, an actual document usage tree 228 might vary significantly in its general appearance, its layout, its extent, the information it provides, and so on.

Therefore, the example document usage tree 228 of FIG. 3 generally illustrates the usage history of a particular electronic document 208. The document usage tree 228 begins with information about the original document 300. A document usage tree 228 will likely include identification and/or address information regarding the computer and/or user that generated each version or copy of an electronic document 208. This identification information also applies to the computer and/or user initiating other document accesses that may have occurred with respect to each version or copy of an electronic document 208.

In the example document usage tree 228 of FIG. 3, the original document 300 does not include any other document access information. Therefore, it is clear that the original document 300 was not accessed for purposes of printing, opening, attaching, and so on. However, the document usage tree 228 indicates that three copies of the original 300 electronic document 208 (i.e., Copy 1, Copy 2, and Copy 3) were made. The document usage tree 228 indicates that Copy 1 and Copy 3 were accessed for various purposes, but that Copy 2 had no accesses. Information regarding Copy 1 indicates that it was opened and printed two times. The date and time that Copy 1 was printed, as well as the printer used, are included in the information for Copy 1. The date and time that Copy 1 was opened, as well as which sections of Copy 1 were viewed, are also included in the information for Copy 1. Similar information is included regarding accesses made for Copy 3.

The document usage tree 228 will continue to grow as more document history 214 information is received and compiled by history compilation application 226. Thus, the document usage tree 228 of FIG. 3 illustrates that further copies of an electronic document 208 were made from some of the first three copies. Copy 1:1 is the first copy made from Copy 1, while Copy 1:2 is the second copy made from Copy 1. Similarly, Copy 3:1 is the first copy made from Copy 3, while Copy 3:2 is the second copy made from Copy 3. The document usage tree 228 also provides information regarding accesses made to these latter copies. Thus, Copy 1:2 includes history information indicating it was opened and printed twice. In addition, the presence of Copy 1:2:1 and Copy 1:2:2 indicated that Copy 1:2 was copied two times.

FIG. 4 is a block diagram illustrating an alternative embodiment of two client computers 104 such as might be implemented in the system environment 100 of FIG. 1. FIG. 4 also includes a block representing a printer/MFP 102 to illustrate general functional aspects of the system 100. The client computers 104 of FIG. 4 are generally configured in the same manner as the client computer 104 discussed above with respect to the FIG. 2 embodiment. Thus, the client computers 104 of FIG. 4 both illustrate a processor 200, a volatile memory 202 (i.e., RAM), and a nonvolatile memory 204 (e.g., ROM, hard disk, floppy disk, CD-ROM, etc.) configured in the same manner as discussed above.

The FIG. 4 embodiment is intended to illustrate that a client computer 104(1) capable of generating an electronic document 208 having tracking code 212, may also include a history compilation application 226 for generating a document usage tree 228 such as described above with respect to FIGS. 2 and 3. Thus, client computer 104(1) includes application(s) 206 having a document tracking setup module 210 as well as electronic document(s) 208 that might be generated therefrom. In addition, client computer 104(1) includes a history compilation application 226 configured to receive and compile into a document usage tree 228, document history 214 information received from various versions of an electronic document 208 located on client computer 104(1) and/or other client computers such as client computer 104(2). The illustration and description provided above for the document usage tree 228 shown in FIG. 3 is applicable in a similar manner to a document usage tree 228 that might be generated by the system embodiment of FIG. 4.

The system configuration of FIG. 4 may provide an author of an electronic document 208 with more immediate and exclusive feedback regarding how the electronic document 208 is being used than the configuration of FIG. 2 described above. Thus, the system configuration of FIG. 4 may be advantageous for an author wanting to provide a more immediate response to the audience of a particular electronic document 208.

Exemplary Methods for Tracking the Usage of an Electronic Document

Example methods for tracking the usage of an electronic document 208 will now be described with primary reference to the flow diagrams of FIGS. 5-8. The methods apply generally to the exemplary embodiments discussed above with respect to FIGS. 1-4. The elements of the described methods may be performed by any appropriate means including, for example, by the execution of processor-readable instructions defined on a processor-readable media, such as a disk, a ROM or other such memory device.

Referring to the method illustrated in FIG. 5, at block 500, an electronic document is accessed. As discussed above, accessing an electronic document generally includes any manner of activation of the document by an appropriate application program or various actions performed through an application program. At block 502, tracking code located in the electronic document is executed. At block 504, document history information is recorded into the electronic document based on instructions within the tracking code. The document history information generally includes information related to the accessing of the document, such as the particular type of access that triggers the execution of the tracking code (e.g., opening, printing, attaching a document to an email), the identification and address of a computer and/or user that initiates an access, the date and time of an access, the identification of a printing device that implements a document printing access, the sections of a document that are viewed during an access, and so on. At block 506, the document history information is transmitted to an address location based on an address that is stored in the tracking code. The address location is typically the location of a computer or central server having a history compilation application configured to compile the document history information.

Referring now to the method illustrated in FIG. 6, at block 600, document history information is received. The document history information is related to a particular electronic document. At block 602, the document history information is combined with previously received document history information that has been received for the particular electronic document. At block 604, any duplicate document history information is deleted, and at block 606, a record of usage (e.g., a document usage tree) is generated for the electronic document based on the document history information.

Referring now to the method illustrated in FIG. 7, at block 700, an electronic document is generated. At block 702, tracking code is inserted into the electronic document. The tracking code is generally configured to generate and store document history information into the electronic document. At block 704, return address information is embedded into the tracking code. The return address information allows the tracking code to transmit document history information to a computer location to be compiled.

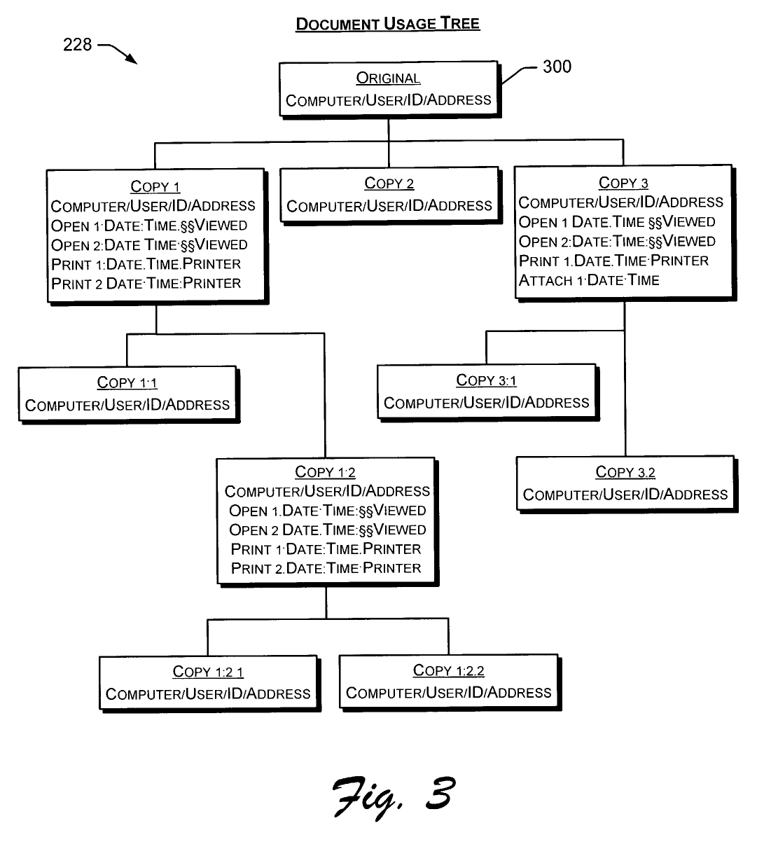

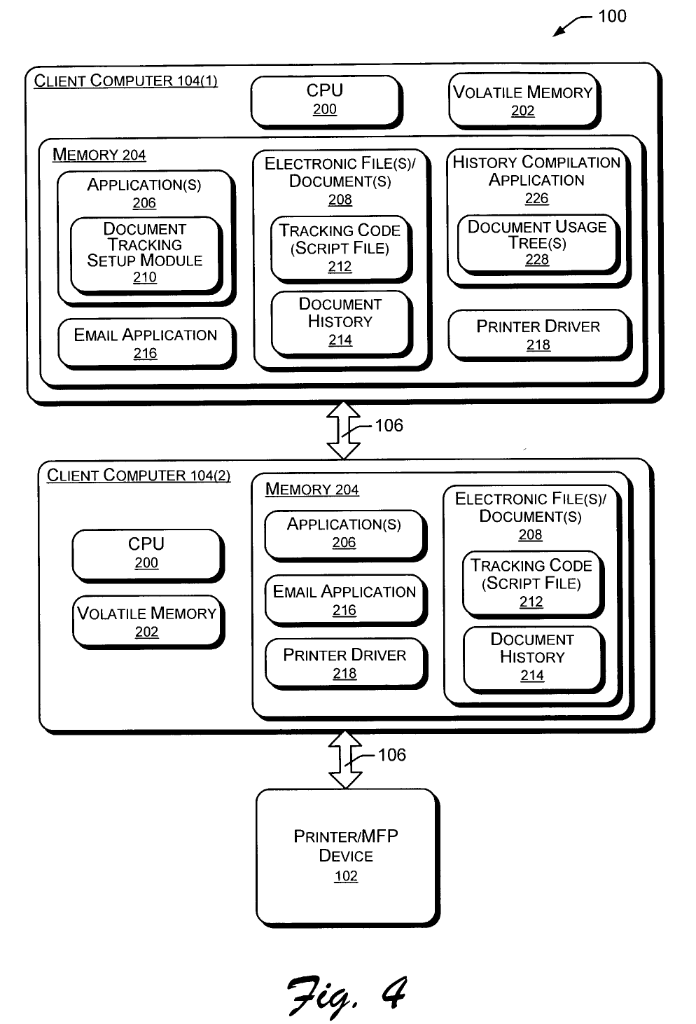

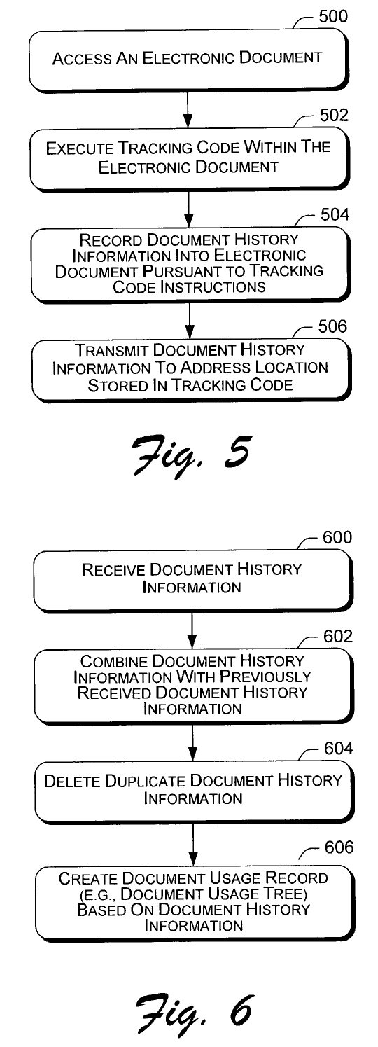

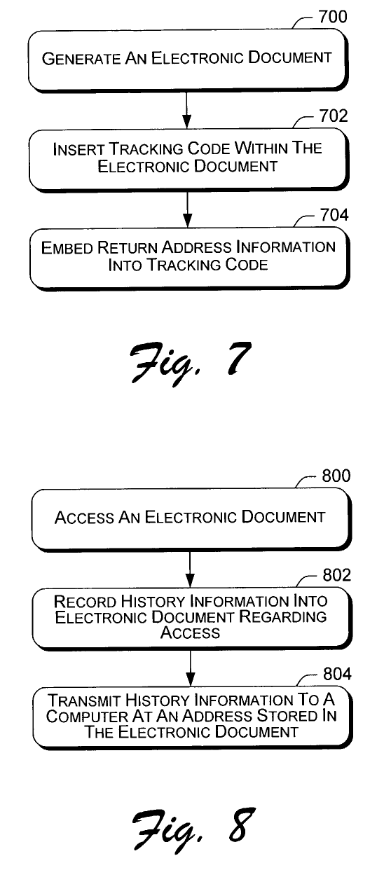

Referring now to the method illustrated in FIG. 8, at block 800, an electronic document is accessed. At block 802, history information relating to the access is recorded into the electronic document. At block 804, the history information is transmitted to a location based on an address stored in the electronic document.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
accessing an electronic document;
in response to the accessing, executing tracking code located within the electronic document; and
recording document history information into the electronic document pursuant to instructions in the tracking code.

2. A processor-readable medium as recited in claim 1, comprising further processor-executable instructions configured for:
pursuant to instructions in the tracking code, transmitting the document history information to a computer at a location determined by an address stored in the tracking code.

3. A processor-readable medium as recited in claim 2, wherein the transmitting further comprises:
activating an email application;
initiating an email message;
attaching the document history information to the email message; and
sending the email message to the address.

4. A processor-readable medium as recited in claim 2, wherein the transmitting further comprises:
initiating a file transfer protocol; and
sending the document history information as a document history file to the address.

5. A processor-readable medium as recited in claim 1, wherein the accessing is an action selected from the group of actions comprising:
opening the electronic document with an application program;
printing the electronic document;
attaching the electronic document to an email; and
copying the electronic document.

6. A processor-readable medium as recited in claim 1, wherein the document history information is information related to the accessing and is selected from the group of information items comprising:
an identification of a computer initiating the accessing;
an address of a computer initiating the accessing;
an identification of a user initiating the accessing;
an identification of a device performing the accessing;
the date of the accessing; and
the time of the accessing.

7. A processor-readable medium as recited in claim 1, wherein the tracking module is programmed in an language selected from the group of languages comprising:
Java;
Perl (Practical Extraction and Reporting Language);
Python;
Visual Basic; and
C-Sharp.

8. A processor-readable medium comprising processor-executable instructions configured for:
receiving document history information; and
compiling the document history information to create a record of usage for an electronic document.

9. A processor-readable medium as recited in claim 8, wherein the compiling further comprises:
combining the document history information with previously received document history information;
deleting duplicate document history information; and
creating a document usage tree based on the document history information.

10. A processor-readable medium as recited in claim 8, wherein the receiving document history information further comprises:
receiving an email message, the email message including a document history attachment;
opening the document history attachment; and
extracting the document history information from the document history attachment.

11. A processor-readable medium as recited in claim 8, comprising further processor-executable instructions configured for displaying the usage tree through a user interface.

12. A processor-readable medium comprising processor-executable instructions configured for:
receiving usage information regarding an electronic document;
compiling the usage information into a usage tree that illustrates a usage history of the electronic document.

13. A processor-readable medium as recited in claim 12, comprising further processor-executable instructions configured for:
eliminating duplicate usage information already present in the usage tree; and
combining the usage information with previously received usage information already present in the usage tree.

14. A processor-readable medium comprising processor-executable instructions configured for:
generating an electronic document; and
inserting tracking code within the electronic document, the tracking code configured to record document history information into the electronic document.

15. A processor-readable medium as recited in claim 14, comprising further processor-executable instructions configured for:
embedding a return address into the tracking code, the tracking code further configured to transfer the document history information to the return address.

16. A processor-readable medium as recited in claim 15, wherein the return address is a user-designated return address.

17. A processor-readable medium comprising processor-executable instructions configured for:
accessing an electronic document; and
recording into the electronic document, history information regarding the accessing.

18. A processor-readable medium as recited in claim 17, comprising further processor-executable instructions configured for transmitting the history information to a computer at a location determined by an address stored in the electronic document.

19. A processor-readable medium as recited in claim 18, wherein the transmitting further comprises:
activating an email application;
initiating an email message addressed to the address;
attaching the document history information to the email message; and
sending the email message.

20. A processor-readable medium as recited in claim 17, wherein the accessing is an event selected from the group of events comprising:
opening the electronic document with an application program;
printing the electronic document;
attaching the electronic document to an email; and
copying the electronic document.

21. A method of tracking the usage of an electronic document comprising:
accessing an electronic document;
executing tracking code located within the electronic document;
pursuant to instructions in the tracking code, recording document history information into the electronic document; and
pursuant to further instructions in the tracking code, transmitting the document history information to a location determined by an address stored in the tracking code.

22. A method of tracking the usage of an electronic document comprising:
receiving document history information; and
creating a document usage tree based on the document history information.

23. A method as recited in claim 22, wherein the creating a document usage tree further comprises:
combining the document history information with previously received document history information; and
deleting duplicate document history information.

24. A method of tracking the usage of an electronic document comprising:
generating an electronic document;
inserting tracking code within the electronic document, the tracking code configured to record document history information into the electronic document; and
entering a user-designated return address into the tracking code, the tracking code further configured to transfer the document history information to the return address.

25. A method of tracking the usage of an electronic document comprising:
accessing an electronic document;
recording history information into the electronic document regarding the accessing; and
transmitting the history information to a computer at a location determined by an address stored in the electronic document.

26. A computer comprising:
an electronic document; and
tracking code configured within the electronic document to execute upon an accessing of the electronic document and to record document history information into the electronic document.

27. A computer as recited in claim 26, further comprising an application program configured to generate the electronic document and to insert the tracking code within the electronic document.

28. A computer as recited in claim 26, further comprising a history compilation application configured to eliminate duplicate usage information and to compile the usage information into a document usage tree.

29. A computer as recited in claim 26, wherein the document history information is selected from the group of information items comprising:
an identification of a computer initiating the accessing;
an address of a computer initiating the accessing;
an identification of a user initiating the accessing;
an identification of a device performing the accessing;
the date of the accessing; and
the time of the accessing.

30. A computer as recited in claim 26, wherein the accessing is an action selected from the group of actions comprising:
opening the electronic document with an application program;
printing the electronic document;
attaching the electronic document to an email; and
copying the electronic document.

31. A computer comprising:
usage information regarding an electronic document; and
a history compilation application configured to compile the usage information into a document usage tree.

32. A computer as recited in claim 31, wherein the usage information is received from a plurality of different computer sources and the history compilation application is further configured to eliminate duplicate usage information.

33. A system comprising:
a computer configured to generate an electronic document having tracking code executable to record document history information into the electronic document; and
a history compilation application executable to compile the usage information.

34. A system as recited in claim 33, wherein the history compilation application is executable on the computer.

35. A system as recited in claim 33, wherein the history compilation application is executable on a central server.
